(19) United States
(12) Patent Application Publication
(10) Pub. No.: US 2024/0091768 A1
(43) Pub. Date: Mar. 21, 2024

(54) LIQUID HANDLING SYSTEM

(71) Applicant: Enplas Corporation, Saitama (JP)

(72) Inventor: Nobuya SUNAGA, Saitama (JP)

(73) Assignee: Enplas Corporation, Saitama (JP)

(21) Appl. No.: 18/273,314

(22) PCT Filed: Feb. 25, 2021
(86) PCT No.: PCT/JP2021/007051

§ 371 Date: Jul. 20, 2023

Related U.S. Application Data
(63) Continuation of application No. PCT/JP2021/002207, filed on Jan. 22, 2021.

(30) Foreign Application Priority Data
Jan. 22, 2021 (WO) PCT/JP2021/002207

(51) Int. Cl. B01L 3/00

(52) U.S. Cl. CPC B01L 3/502715; B01L 2200/025; B01L 2200/027; B01L 2200/04; B01L 2300/0609

(57) ABSTRACT

This liquid handling system comprises a flow channel chip, a chip holder, a cartridge housing liquid to be introduced to the flow channel chip, and a liquid handling device for controlling the flow of the liquid within the flow channel chip housed in the chip holder. The flow channel chip, the chip holder, or the liquid handling device includes a first engaging part, and the cartridge includes a second engaging part. The first engaging part and the second engaging part are configured such that when the first engaging part and the second engaging part are detachably engaged, a communicating pipe of the cartridge is connected to an introduction port of the flow channel chip and packing on the cartridge is pressed by the introduction port.

### TECHNICAL FIELD

The present invention relates to a liquid handling system.

### BACKGROUND ART

In recent years, microwell plates, channel chips, and the like are used to analyze, for example, cells, proteins, and nucleic acids. Microwell plates and channel chips are advantageous such that only a small amount of reagents and samples is required for analysis, thus are expected to be used in a variety of applications such as clinical tests, food tests, and environment tests.

Patent Literature (hereinafter, referred to as PTL) 1, for example, discloses a reaction container including a sample container for housing a sample, a sample container housing part for housing the sample container, and a sample channel connected to the sample container housed in the sample container housing part. The sample container includes a plurality of locking grooves on the surface thereof, and the sample container housing part includes a plurality of locking claws. By engaging the locking claws with the locking grooves, the sample container is held in the sample container housing part at a predetermined position.

### CITATION LIST

### Patent Literature

PTL 1

WO2009/072332

### SUMMARY OF INVENTION

### Technical Problem

Regarding the reaction container described in PTL 1, the sample container is not configured to be detached from the sample container housing part. Once the sample container is housed in the sample container housing part, it is difficult to remove the sample container.

An object of the present invention is to provide a liquid handling system including a channel chip and a cartridge containing a liquid to be introduced into the channel chip, and in the liquid handling system, the cartridge can be fixed to or removed from the channel chip.

### Solution to Problem

A liquid handling system of the present invention includes the following: a channel chip including an introduction port for introducing a liquid and a channel for allowing a liquid introduced from the introduction port to flow therethrough; a chip holder for housing the channel chip; a cartridge housing a liquid to be introduced into the introduction port; and a liquid handling device for supporting the chip holder and for controlling a flow of a liquid in the channel chip housed in the chip holder, in which the channel chip, the chip holder, or the liquid handling device includes a first engagement part, and the cartridge includes: a housing part housing a liquid; a communication pipe configured to allow the housing part and the introduction port to communicate with each other; packing disposed at the communication pipe, and a second engagement part configured to detachably engage with the first engagement part, in which the first engagement part and the second engagement part are configured in such a way that when the first engagement part and the second engagement part detachably engage with each other, the communication pipe is connected to the introduction port while the packing is pressed by the introduction port.

### Advantageous Effects of Invention

The present invention is capable of providing a liquid handling system including a channel chip and a cartridge containing a liquid to be introduced into the channel chip, and in the liquid handling system, the cartridge can be fixed to or removed from the channel chip.

### BRIEF DESCRIPTION OF DRAWINGS

FIG. 1A is a perspective view of a liquid handling system according to Embodiment 1 of the present invention, and FIG. 1B is a plan view of the liquid handling system according to Embodiment 1;

FIG. 2 is a plan view of the liquid handling system according to Embodiment 1 before a cartridge is attached thereto;

FIG. 3 is a perspective view of the cartridge;

FIG. 4 is a schematic cross-sectional view taken along line A-A in FIG. 1A;

FIG. 5 is a cross-sectional view taken along line B-B in FIG. 1B;

FIG. 6A is a plan view of a channel chip, FIG. 6B is a bottom view of the channel chip, and FIG. 6C is a bottom view of a substrate;

FIG. 7 is a bottom view of the channel chip;

FIG. 8A is a perspective view of a liquid handling system according to Embodiment 2 of the present invention, and FIG. 8B a plan view of the liquid handling system according to Embodiment 2;

FIG. 9 is a schematic cross-sectional view taken along line A-A in FIG. 8B;

FIG. 10 is a perspective view of a cartridge;

FIG. 11A is a perspective view of the cartridge with channels, each of which is between a housing part and a packing and in a “closed” state, FIG. 11B is a bottom view of the cartridge with the channels in the “closed” state, FIG. 11C is a schematic cross-sectional view taken along line A-A in FIG. 11A, FIG. 11D is a perspective view of the cartridge with the channels, each of which is between a housing part and a packing and in an “opened” state, FIG. 11E is a bottom view of the cartridge with the channels in the “opened” state, and FIG. 11F is a schematic cross-sectional view taken along line A-A in FIG. 11D;

FIG. 12A is a plan view of part of the liquid handling system before communication pipes of the cartridge are inserted into through holes, and FIG. 12B is a cross-sectional view taken along line A-A in FIG. 12A;

FIG. 13A is a plan view of part of the liquid handling system after the communication pipes of the cartridge are inserted into the through holes, and FIG. 13B is a cross-sectional view taken along line A-A in FIG. 13A; and

FIG. 14A is a plan view of part of the liquid handling system after second engagement parts are engaged with first engagement parts, and FIG. 14B is a cross-sectional view taken along line A-A in FIG. 14A.

### DESCRIPTION OF EMBODIMENTS

Hereinafter, a liquid handling system according to an embodiment of the present invention will be described.

### Embodiment 1

Configuration of Liquid Handling System

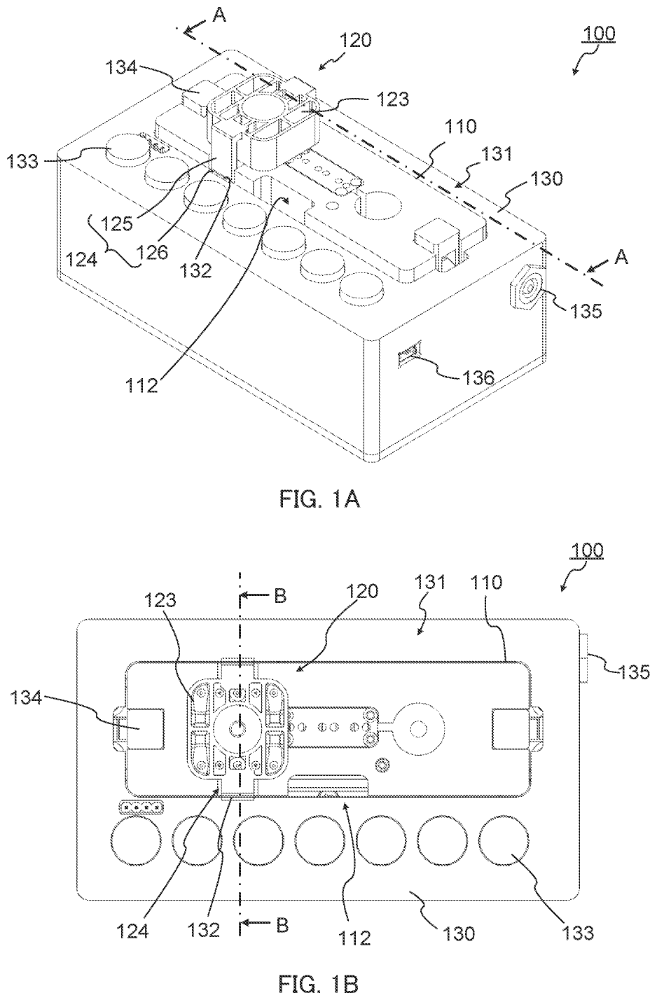

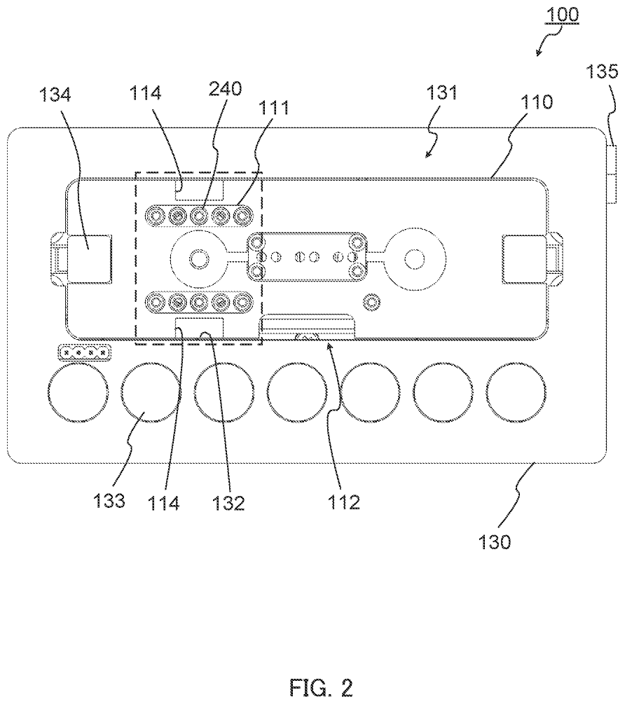

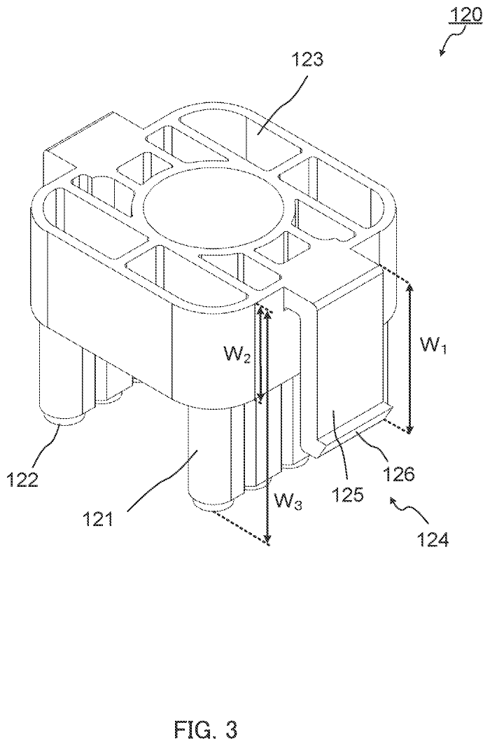

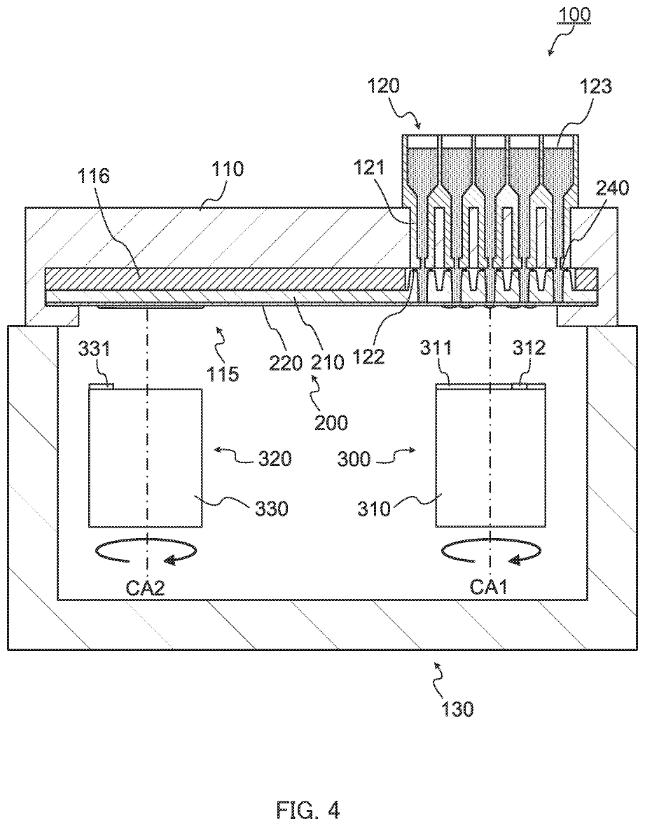

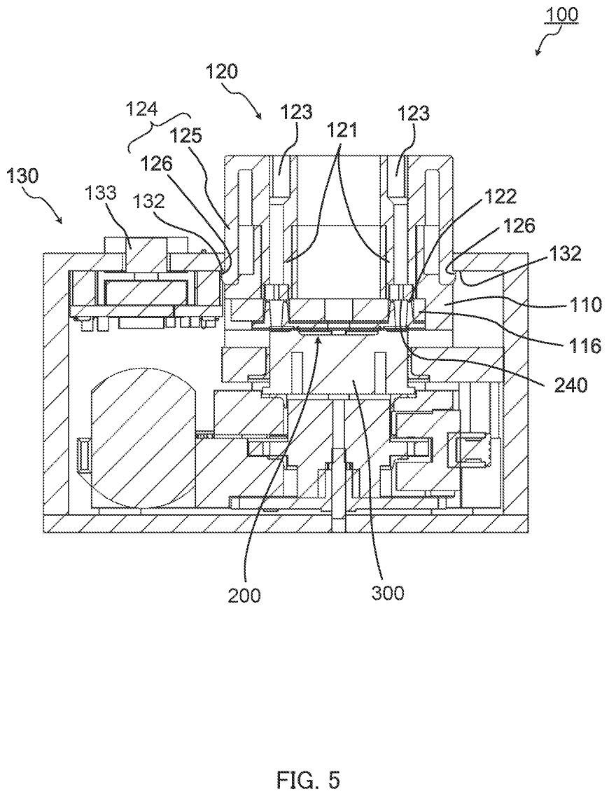

FIG. 1A is a perspective view of liquid handling system 100 according to Embodiment 1. FIG. 1B is a plan view of liquid handling system 100. FIG. 2 is a plan view of liquid handling system 100 before cartridge 120 is attached thereto. FIG. 3 is a perspective view of cartridge 120. FIG. 4 is a schematic cross-sectional view taken along line A-A in FIG. 1A. FIG. 5 is a cross-sectional view taken along line B-B in FIG. 1B. In FIG. 4, for easier understanding of the configuration of liquid handling system 100, some components are omitted, and channel chip 200 and rotary members (first rotary member 300 and second rotary member 320) are illustrated separately.

As illustrated in FIGS. 1A, 1B, 2, 3, 4, and 5, liquid handling system 100 includes channel chip 200, chip holder 110 for housing channel chip 200, cartridge 120 housing a liquid to be introduced into channel chip 200, and liquid handling device 130 for supporting chip holder 110 and for controlling the flow of the liquid in channel chip 200 housed in chip holder 110.

Configuration of Chip Holder

As illustrated in FIG. 4, chip holder 110 houses below described channel chip 200 and is disposed in liquid handling device 130 at a predetermined position. In the present embodiment, channel chip 200 is housed in chip holder 110 while plate-shaped spacer 116 for filling the space in chip holder 110 is disposed on a portion other than introduction ports 240 located at the top surface of channel chip 200.

As illustrated in FIG. 2, through holes 111, first opening 112, recesses 114, and second opening 115 (see FIG. 4) are formed in chip holder 110.

Through hole 111 is formed in the top surface of chip holder 110, and allows thereto insertion of communication pipes 121 of cartridge 120. In the present embodiment, the number of through holes 111 is two. In the present embodiment, through hole 111 has a size in plan view such that five introduction ports 240 can be housed therein.

First opening 112 is formed in the front surface of chip holder 110 and is used for placing or removing channel chip 200.

Recesses 114 are formed in the top surface, front surface and rear surface of chip holder 110 and each configured to house corresponding one of two second engagement parts 124 of cartridge 120. In the present embodiment, the number of second engagement parts 124 is two; thus the number of recesses 114 is two (a pair).

Second opening 115 is formed in the bottom surface of chip holder 110 (the surface to contact film 220 of channel chip 200). First rotary member 300 and second rotary member 320 contact the bottom surface (the surface to which film 220 is bonded) of channel chip 200 through second opening 115 (see FIGS. 4 and 5).

The shapes of chip holder 110, through hole 111, first opening 112, second opening 115, and recess 114 are not limited as long as the components can exhibit their respective functions.

Configuration of Cartridge

Cartridge 120 houses a liquid to be introduced into introduction port 240 of channel chip 200. As illustrated in FIG. 3, cartridge 120 includes communication pipes 121, pieces of packing 122 each disposed at the tip of communication pipe 121, housing parts 123 for housing liquid, and second engagement parts 124. Communication pipe 121 is configured to allow housing part 123 and introduction port 240 to communicate with each other when cartridge 120 is fixed to chip holder 110, and second engagement part 124 is configured to detachably engage with below described first engagement part 132 of liquid handling device 130.

The material for cartridge 120 can be appropriately selected from known resins or metals. In the present embodiment, cartridge 120 is preferably made of a material that allows bending part 125 of second engagement part 124 to have elasticity. Examples of the material for cartridge 120 include polyethylene terephthalate, polycarbonate, polymethyl methacrylate, polyvinyl chloride, polypropylene, polyether, polyethylene, polystyrene, cyclo-olefine resins, silicone resins, and elastomers.

Communication pipe 121 allows housing part 123 and introduction port 240 to communicate with each other when cartridge 120 is fixed to chip holder 110. Communication pipe 121 may have any diameter as long as the communication pipe can exhibit the above function.

Packing 122 is disposed at the tip of communication pipe 121 of cartridge 120. The material for packing 122 is not limited as long as the packing can exhibit elasticity such that the packing collapses when pressed, thereby sealing the internal space of communication pipe 121 and introduction port 240 from the outside. Examples of the material for packing 122 include known rubbers or elastomers.

Housing part 123 temporarily stores a liquid. The number of housing parts 123 is not limited, that is, any number can be selected depending on the types of reagents, liquid samples, washing liquids, and the like desired to be housed. In the present embodiment, the number of housing parts 123 is 10. The shape and volume of housing part 123 are not limited, either. For example, the volume of each housing part 123 is such that the housing part can contain approximately 20 to 200 μL of liquid.

In addition, it is preferable that housing part 123 is sealed by, for example, heat sealing. Such a configuration can prevent foreign substances from entering housing part 123.

Second engagement part 124 engages with first engagement part 132 described below. Second engagement part 124 may have any configuration as long as the second engagement part can exhibit the above functions. In the present embodiment, first engagement part 132 and second engagement part 124 are detachably engaged with each other by a snap fit mechanism. More specifically, second engagement part 124 includes bending part 125 and claw 126. Bending part 125 extends along the extending direction of communication pipe 121, and claw 126 protrudes toward the side opposite to housing part 123 and located at the end portion of bending part 125, the end portion on the channel chip 200 side (the side closer to first engagement part 132). In the present embodiment, second engagement part 124 is configured in such a way that length W₁ thereof is longer than length W₂ of housing part 123 in the depth direction, and length W₁ is shorter than the total length W₃ of length W₂ of housing part 123 and the length of communication pipe 121, and second engagement part 124 is disposed so as to be separated from communication pipe 121 and housing part 123 (see FIG. 3). Accordingly, when second engagement part 124 is pressed, bending part 125 can be bent toward housing part 123.

When cartridge 120 is installed at the position surrounded by the dashed line in FIG. 2, housing part 123 and introduction port 240 communicate with each other through communication pipe 121. When packing 122 is pressed by communication pipe 121 and introduction port 240 due to external pressure, packing 122 collapses to seal introduction port 240. At this time, bending part 125 of second engagement part 124 bends, allowing claw 126, which is protruding away from housing part 123, to detachably engage with first engagement part 132 of liquid handling device 130 by a snap fit mechanism (see FIG. 5). As a result, cartridge 120 is fixed at the optimum position with respect to channel chip 200. As will be described below, first engagement part 132 may be disposed at chip holder 110 or channel chip 200 instead of liquid handling device 130.

Configuration of Liquid Handling Device

Liquid handling device 130 is configured to support chip holder 110 and control the flow of the liquid in channel chip 200 housed in chip holder 110. As illustrated in FIGS. 1A and 1B, liquid handling device 130 includes disposition part 131 for supporting chip holder 110, first engagement parts 132 to be engaged with second engagement parts 124 of cartridge 120, a plurality of buttons 133 for starting liquid handling device 130 and controlling the operation of liquid handling device 130, and fixing parts 134 for fixing chip holder 110. Liquid handling device 130 may further include jack 135 into which an AC adapter plug is inserted, and connector 136 into which a USB connector is inserted. Furthermore, liquid handling device 130 may further include first rotary member 300 and second rotary member 320.

Disposition part 131 supports chip holder 110. Disposition part 131 may have any configuration as long as the disposition part can exhibit the above function. In the present embodiment, the shape of disposition part 131 in plan view is substantially similar to the shape of chip holder 110 in plan view. Disposition part 131 is formed to have a shape slightly larger than that of chip holder 110 in plan view. In the present embodiment, disposition part 131 is a recess in which at least part of chip holder 110 is disposed.

First engagement part 132 is a portion configured to be engaged with second engagement part 124. Disposing first engagement part 132 at an appropriate position can fix cartridge 120 to channel chip 200 at the optimum position when first engagement part 132 and second engagement part 124 are engaged with each other. In the present embodiment, first engagement part 132 is disposed in liquid handling device 130. More specifically, first engagement part 132 is the edge of the opening of the casing of liquid handling device 130. First engagement part 132 may be disposed in, for example, chip holder 110 or channel chip 200. The configuration of first engagement part 132 is not limited as long as the first engagement part can exhibit the above function and is appropriately set according to the configuration of second engagement part 124. As described above, in the present embodiment, first engagement part 132 and second engagement part 124 are detachably engaged with each other by a snap fit mechanism.

As illustrated in FIG. 4, liquid handling device 130 further includes first rotary member 300 and second rotary member 320. Channel chip 200 is installed in such a way that film 220 contacts first rotary member 300 and second rotary member 320.

First rotary member 300 includes cylindrical first main body 310 and first protrusion 311 disposed on the top surface of first main body 310, and is rotated about first central axis CA1 by a drive mechanism (not illustrated).

The upper portion of first main body 310 is provided with first protrusion 311 configured to close valve 250 by pressing the diaphragm of valve 250 and first recess 312 configured to open the valve by not pressing the diaphragm. First protrusion 311 and first recess 312 are disposed on the circumference of a circle whose center is first central axis CA2. In the present embodiment, first protrusion 311 in plan view has a shape of an arc (“C” shape) corresponding to a portion of the circle whose center is first central axis CA2. The region, on the circumference, where first protrusion 311 is not present is first recess 312.

Second rotary member 320 includes cylindrical second main body 330 and second protrusion 331 disposed on the top surface of second main body 330, and is rotated about second central axis CA2 by a drive mechanism (not illustrated).

The upper portion of second main body 330 is provided with second protrusion 331 configured to operate rotary membrane pump 260 by pressing diaphragm 261 of rotary membrane pump 260 while second protrusion 331 is sliding along diaphragm 261. Second protrusion 331 is disposed on the circumference of a circle whose center is second central axis CA2. Second protrusion 331 may have any shape as long as rotary membrane pump 260 can be operated appropriately. In the present embodiment, second protrusion 331 in plan view has a shape of an arc corresponding to a portion of the circle whose center is second central axis CA2.

In liquid handling system 100 according to the present embodiment, first protrusion 311 of first rotary member 300 controls opening and closing of the plurality of valves 250 of channel chip 200. For achieving such control, plurality of valves 250 of channel chip 200 and first protrusion 311 of first rotary member 300 are disposed on the circumference of the first circle whose center is first central axis CA2.

In a similar manner, in liquid handling system 100 according to the present embodiment, second protrusion 331 of second rotary member 320 controls the operation of rotary membrane pump 260 of channel chip 200. For achieving such control, rotary membrane pump 260 of channel chip 200 and second protrusion 331 of second rotary member 320 are disposed on the circumference of the second circle whose center is second central axis CA2.

Configuration of Channel Chip

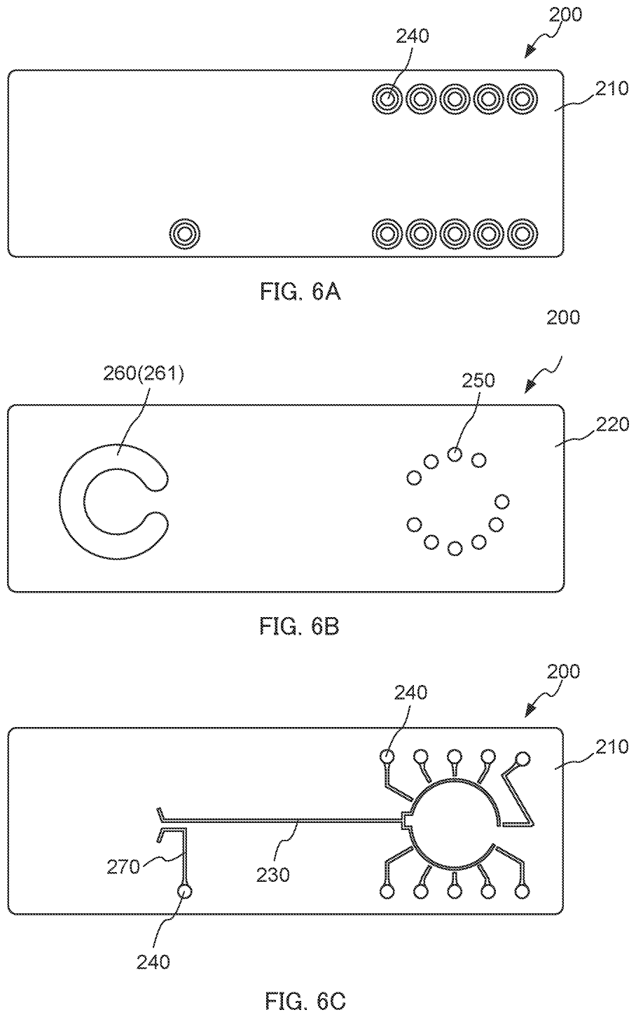

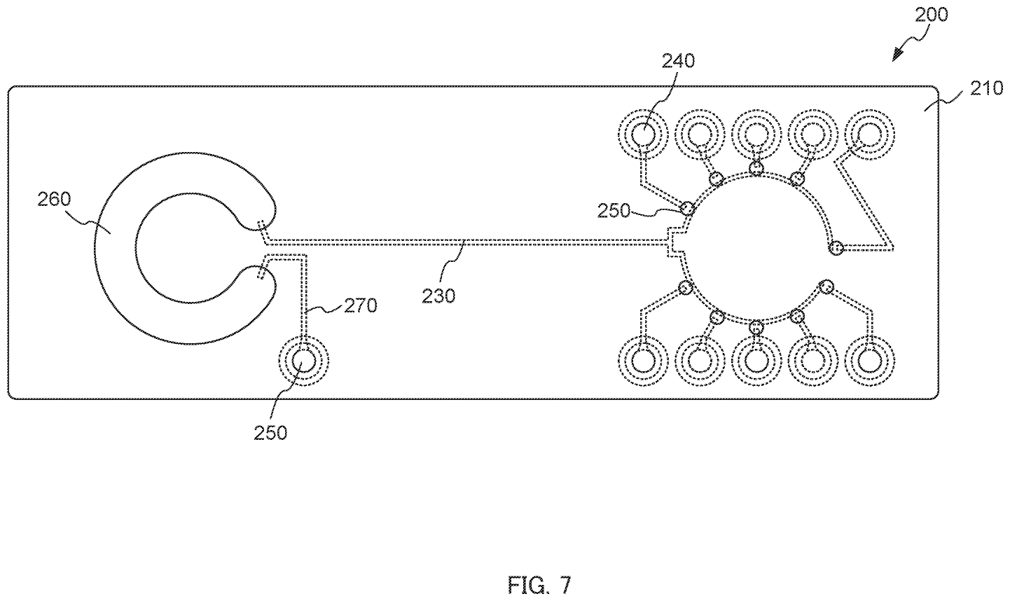

FIG. 6A is a plan view of channel chip 200 (plan view of substrate 210). FIG. 6B is a bottom view of channel chip 200 (bottom view of film 220). FIG. 6C is a bottom view of substrate 210 (bottom view of channel chip 200 with film 220 removed). FIG. 7 is a bottom view of channel chip 200. In FIG. 7, internal components such as channels are indicated by dashed lines.

Channel chip 200 is configured to be housed in chip holder 110 and disposed at a predetermined location of liquid handling device 130 for supporting chip holder 110 (see FIGS. 1A and 4).

Channel chip 200 includes substrate 210 and film 220. In substrate 210, grooves to serve as channels, a recess to serve as a chamber, and through holes to serve as introduction ports or discharge ports are formed. Film 220 is joined to one of the surfaces of substrate 210 so as to block the openings of the recesses and through holes formed in substrate 210 (see FIG. 4). Some regions of film 220 function as diaphragms. The grooves of substrate 210 blocked by film 220 serve as channels that allow liquids, such as reagents, liquid samples, and washing liquids, to flow therethrough.

The thickness of substrate 210 is not limited. For example, the thickness of substrate 210 is 1 mm or more and 10 mm or less. In addition, the material for substrate 210 is not limited. For example, the material for substrate 210 may be appropriately selected from known resins and glass. Examples of the material for substrate 210 include polyethylene terephthalate, polycarbonate, polymethyl methacrylate, polyvinyl chloride, polypropylene, polyether, polyethylene, polystyrene, cyclo-olefine resins, silicone resins, and elastomers.

The thickness of film 220 is not limited as long as the film can function as a diaphragm. For example, the thickness of film 220 is 30 μm or more and 300 μm or less. The material for film 220 is not limited either as long as the film can function as a diaphragm. For example, the material for film 220 may be appropriately selected from known resins. Examples of the material for film 220 include polyethylene terephthalate, polycarbonate, polymethyl methacrylate, polyvinyl chloride, polypropylene, polyether, polyethylene, polystyrene, cyclo-olefine resins, silicone resins, and elastomers. Film 220 is joined to substrate 210 by, for example, heat welding, laser welding, or an adhesive.

In the present embodiment, channel chip 200 includes a plurality of first channels 230, a plurality of introduction ports (wells) 240 each connected to first channel 230, and a plurality of valves 250 each disposed between introduction port 240 and first channel 230. The numbers of introduction ports 240 and valves 250 are not limited, and are appropriately set according to the application of the channel chip 200.

Introduction port 240 is a bottomed recess for introducing a sample such as blood, a washing liquid, or the like. As described above, communication pipe 121 of cartridge 120 is inserted into introduction port 240. In the present embodiment, each of these recesses is composed of a through hole formed in substrate 210 and film 220 blocking one of the openings of the through hole. The shape and size of each recesses are not limited, and can be appropriately set according to the shape of communication pipe 121. The shape of these recesses is, for example, substantially cylindrical. The width of these recesses is, for example, approximately 2 mm.

First channel 230 is a channel through which liquid can move. In the upstream end thereof, first channel 230 is connected to introduction ports 240 at different positions. The downstream end of first channel 230 is connected to rotary membrane pump 260. First channel 230 is composed of a groove formed in substrate 210 and film 220 blocking the opening of the groove. The cross-sectional area and cross-sectional shape of first channel 230 are not limited. Herein, a “cross section of a channel” means a cross section—orthogonal to the direction in which a liquid flows—of a channel. The cross-sectional shape of each channel is, for example, a substantially rectangular shape with a side length (width and depth) of about several tens of μm. The cross-sectional area of each channel may or may not be constant in the direction of fluid flow. In the present embodiment, the cross-sectional area of each channel is constant.

Each valve 250 is a membrane valve (diaphragm valve) disposed between first channel 230 and corresponding one of introduction ports 240, and configured to control the flow of liquid between the first channel and the introduction port. In the present embodiment, each valve is a rotary membrane valve whose opening and closing are controlled by the rotation of first rotary member 300. In the present embodiment, these valves are disposed on the circumference of one circle whose center is first central axis CA1.

Rotary membrane pump 260 is a space which has a substantially arc shape (“C” shape) in plan view and is formed between substrate 210 and film 220. The upstream end of rotary membrane pump 260 is connected to first channel 230, and the downstream end of rotary membrane pump 260 is connected to second channel 270. Second channel 270 is composed of a groove formed in substrate 210 and film 220 blocking the opening of the groove. In the present embodiment, rotary membrane pump 260 is composed of the bottom surface of substrate 210 and diaphragm 261 facing the bottom surface while being separated from the bottom surface. Diaphragm 261 is a portion of flexible film 220 (see FIG. 6B). Diaphragm 261 is disposed on the circumference of one circle whose center is second central axis CA2. The shape of a cross section—orthogonal to the circumference—of diaphragm 261 is not limited, and is arc-shaped in the present embodiment.

Diaphragm 261 of rotary membrane pump 260 bends and contacts substrate 210 when pressed by second protrusion 331 of second rotary member 320. For example, when second protrusion 331 slides along and presses diaphragm 261 from the connection part with first channel 230 toward the connection part with second channel 270 (counterclockwise in FIG. 7), the fluid in first channel 230 moves toward rotary membrane pump 260 and the pressure inside first channel 230 becomes negative, and the fluid in rotary membrane pump 260 moves toward second channel 270 and the pressure inside second channel 270 becomes positive. On the other hand, when second protrusion 331 slides along and presses diaphragm 261 from the connection part with second channel 270 toward the connection part with first channel 230 (clockwise in FIG. 7), the fluid in second channel 270 moves toward rotary membrane pump 260 and the pressure inside second channel 270 becomes negative, and the fluid (for example, air) in rotary membrane pump 260 moves toward first channel 230 and the pressure inside first channel 230 becomes positive.

Operation of Liquid Handling System

Hereinafter, a method for using liquid handling system 100 according to the present embodiment will be described.

First, channel chip 200 is inserted into chip holder 110 together with spacer 116 to dispose chip holder 110 in disposition part 131 of liquid handling device 130. Chip holder 110 is fixed by fixing parts 134 located on the upper portion of liquid handling device 130.

Next, cartridge 120 is installed at a predetermined position on chip holder 110 (the position indicated by the dashed line in FIG. 2). At this time, cartridge 120 is pressed toward chip holder 110 until second engagement part 124 of cartridge 120 engages first engagement part 132. As a result, communication pipes 121 of cartridge 120 are inserted into introduction ports 240 of channel chip 200, and housing parts 123 of cartridge 120 communicate with corresponding introduction ports 240 of channel chip 200. In addition, packing 122 disposed at the tip of each communication pipe 121 is pressed by communication pipe 121 and introduction port 240 to seal introduction port 240. In this state, cartridge 120 is fixed to channel chip 200 and to liquid handling device 130, and the liquid inside housing part 123 is introduced into introduction port 240.

With cartridge 120 fixed, button 133 disposed on liquid handling device 130 is pressed, thereby performing various processes, such as rotating first rotary member 300 to open and close the valves or rotating second rotary member 320 to drive the rotary membrane pump to move the liquid from introduction port 240 as illustrated in FIG. 4.

After various processes are completed, the engaged state between first engagement part 132 and second engagement part 124 can be easily released by pressing bending part 125 inward (toward the housing part 123).

Effects

As described above, in liquid handling system 100 according to the present embodiment, cartridge 120 can be easily fixed to or removed from channel chip 200.

In the above-described embodiment, second engagement part 124 of cartridge 120 is pressed to be bent, thereby releasing the engaged state between first engagement part 132 and second engagement part 124; however, the present invention is not limited thereto. For example, second engagement part 124 may include, at an appropriate position, a protrusion for releasing the engaged state between first engagement part 132 and second engagement part 124. Alternatively, first engagement part 132 may be a groove included in chip holder 110 and second engagement part 124 may be a projection configured to engage the groove. Furthermore, first engagement part 132 may include a first groove extending along the extending direction of communication pipe 121 and a second groove connected to the first groove and extending in a direction orthogonal to the extending direction of communication pipe 121 (see Embodiment 2).

### Embodiment 2

Hereinafter, liquid handling system 500 according to Embodiment 2 will be described. Liquid handling system 500 according to the present embodiment differs from liquid handling system 100 according to Embodiment 1 in the shapes of chip holder 510, cartridge 520, and liquid handling device 530. Therefore, in the present embodiment, the same components as those of liquid handling system 100 according to Embodiment 1 are denoted by the same reference numerals, and descriptions thereof are omitted.

Configuration of Liquid Handling System

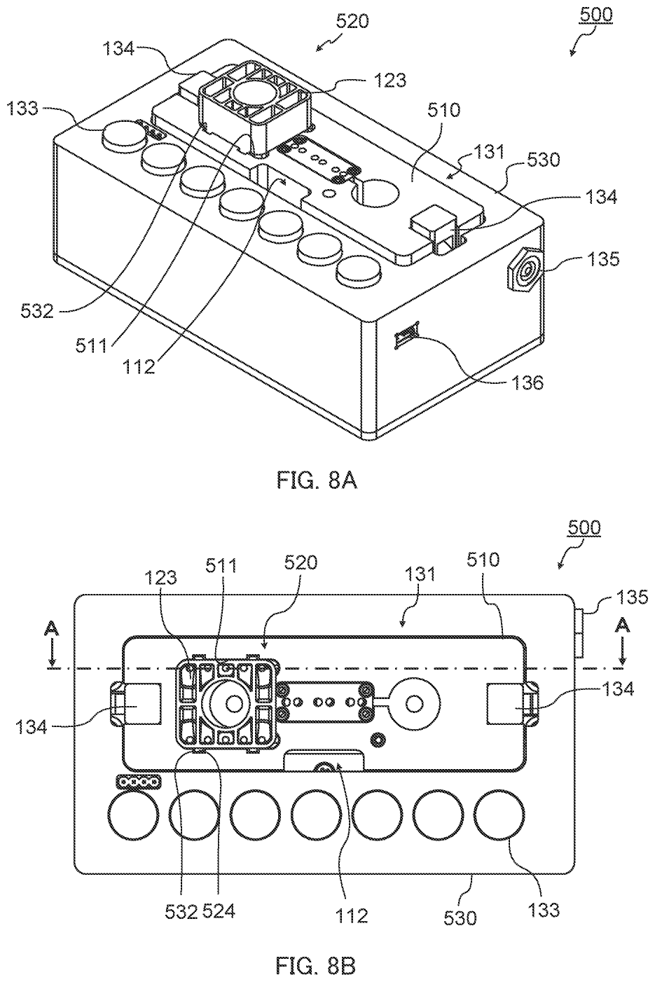

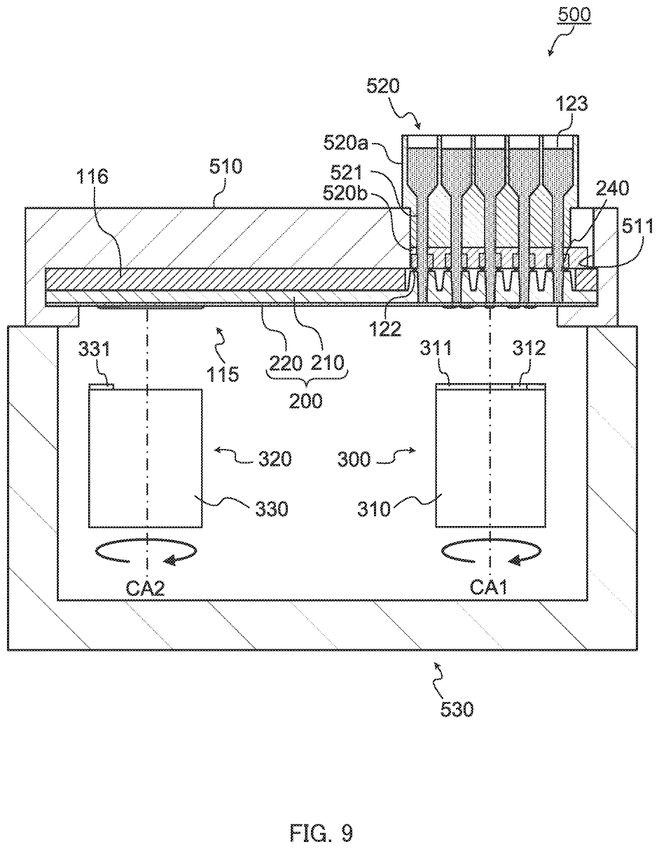

FIG. 8A is a perspective view of liquid handling system 500 according to Embodiment 2. FIG. 8B is a plan view of liquid handling system 500. FIG. 9 is a schematic cross-sectional view taken along line A-A in FIG. 8B. In FIG. 9, for easier understanding of the configuration of liquid handling system 500, some components are omitted, and channel chip 200 and rotary members (first rotary member 300 and second rotary member 320) are illustrated separately.

As illustrated in FIGS. 8A, 8B, and 9, liquid handling system 500 according to the present embodiment includes channel chip 200, chip holder 510, cartridge 520, and liquid handling device 530.

The configuration of channel chip 200 is the same as that of channel chip 200 in Embodiment 1; thus, the description thereof is omitted.

Through holes 511, first opening 112, and second opening 115 are formed in chip holder 510. That is, chip holder 510 according to the present embodiment does not include recess 114 of Embodiment 1.

Through hole 511 is formed in the top surface of chip holder 510, and functions to allow insertion of communication pipes 121 of cartridge 120. In the present embodiment, the number of through holes 511 is two. In the present embodiment, through hole 511 has a size in plan view such that five introduction ports 240 can be housed therein. First engagement parts 532 are formed in each of the two through holes 511.

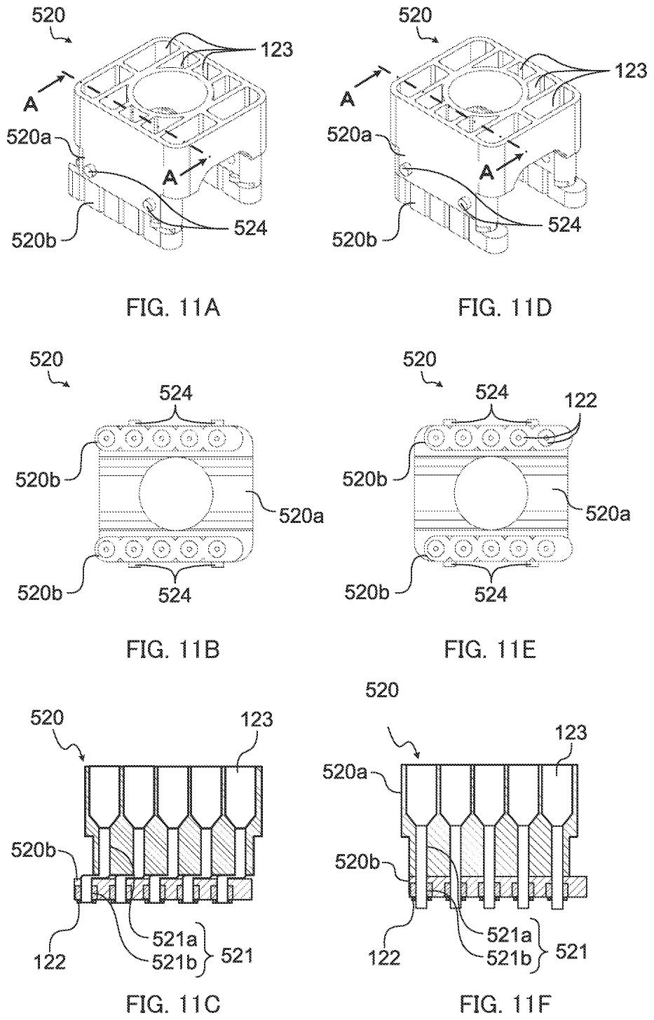

First engagement part 532 may have any configuration as long as the first engagement part can be engaged with second engagement part 524 and can be detachably engaged with second engagement part 524. In the present embodiment, first engagement part 532 includes first groove 532a and second groove 532b (see FIGS. 11, 12, and 13). First engagement part 532 is formed on one of the inner side surfaces of through hole 511— the one inner side surface is located along the longitudinal axis of chip holder 510 when chip holder 510 is viewed in plan view. The number of first engagement parts 532 is not limited as long as cartridge 520 can be fixed to chip holder 510 by engaging first engagement parts 532 with second engagement parts 524. In the present embodiment, two first engagement parts 532 are formed in one through hole 511. That is, the number of first engagement parts 532 is four in the present embodiment.

First engagement part 532 includes first groove 532a and second groove 532b. First groove 532a is formed along the extending direction of communication pipe 521. Second groove 532b is formed along a direction orthogonal to the extending direction of communication pipe 521 (longitudinal axis direction of chip holder 510). First groove 532a and second groove 532b may have any width as long as the grooves are large enough for the projection of second engagement part 524 to fit therein. The width of first groove 532a may be the same as or different from the width of second groove 532b. In the present embodiment, width of first groove 532a is the same as the width of second groove 532b. The side walls of first grooves 532a may or may not be continuous. Similarly, the side walls of second grooves 532b may or may not be continuous.

Configuration of Cartridge

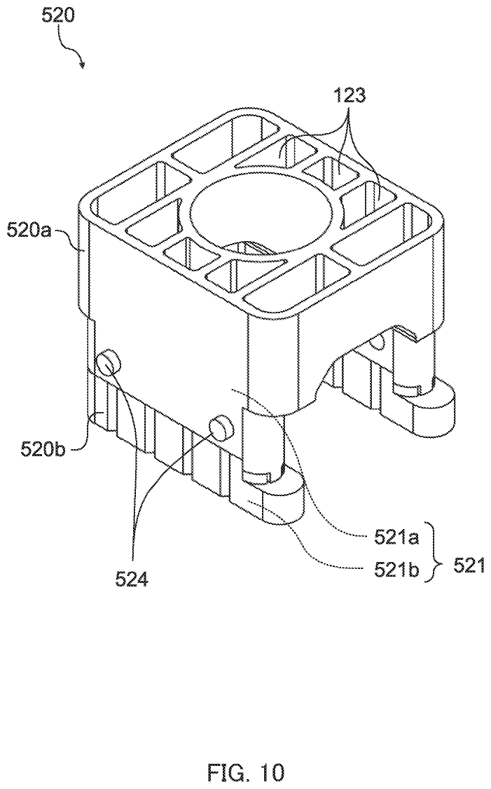

FIG. 10 is a perspective view of cartridge 520.

As illustrated in FIG. 10, cartridge 520 includes cartridge main body 520a and slide part 520b.

Cartridge main body 520a is configured to be slidable with respect to slide part 520b. Cartridge main body 520a includes housing parts 123, second engagement parts 524, and first communication pipes 521a—each first communication pipe is a portion of communication pipe 521 on the housing part 123 side.

Second engagement part 524 is included in cartridge main body 520a or in slide part 520b. In the present embodiment, second engagement part 524 is formed on the outer side surface of cartridge main body 520a. The number of second engagement parts 524 is not limited as long as cartridge 520 can be fixed to chip holder 510 by engaging second engagement parts 524 with first engagement parts 532. In the present embodiment, the number of second engagement parts 524 is four. Second engagement part 524 may have any shape as long as the second engagement part can engage with first engagement part 532 and slide with respect to first engagement part 532. In the present embodiment, second engagement part 524 has a shape of a substantially cylindrical projection.

First communication pipe 521a is a portion of communication pipe 521 on the upstream side. The upstream end of first communication pipe 521a is connected to housing part 123, and the downstream end of first communication pipe 521a is connected to second communication pipe 521b.

Slide part 520b includes pieces of packing 122 and second communication pipes 521b (each located on the downstream side of communication pipe 521), and is configured to be slidable with respect to cartridge main body 520a.

Second communication pipe 521b is a portion of communication pipe 521 on the packing 122 side. The upstream end of second communication pipe 521b is connected to first communication pipe 521a, and the packing 122 is disposed at the downstream end of second communication pipe 521b.

Communication pipe 521 connects housing part 123 with packing 122 regardless of whether the channel between housing part 123 and packing 122 is in a communicating state or the channel between housing part 123 and packing 122 is in a blocked state. The material for communication pipe 521 is not limited as long as the connection between housing part 123 and packing 122 can be maintained. Examples of the material for communication pipe 521 include silicone, urethane, polytetrafluoroethylene (PTFE), and Tygon (registered trademark) of polyvinyl chloride resin.

In the following, a mechanism for opening and closing the channel between housing part 123 and packing 122 will be described. FIG. 11A is a perspective view of cartridge 520 with channels, each of which is between housing part 123 and packing 122 and in a “closed” state. FIG. 11B is a bottom view of cartridge 520 with the channel in the “closed” state. FIG. 11C is a schematic cross-sectional view taken along line A-A in FIG. 11A. FIG. 11D is a perspective view of cartridge 520 with the channels, each of which is between housing part 123 and packing 122 and in an “opened” state. FIG. 11E is a bottom view of cartridge 520 with the channel in the “opened” state. FIG. 11F is a schematic cross-sectional view taken along line A-A in FIG. 11D.

As illustrated in FIGS. 11A to 11C, when the channel between housing part 123 and packing 122 is in the “closed” state (in the case of cartridge 520 alone), one end of communication pipe 521 (the upstream end of first communication pipe 521a) is connected to housing part 123, and the other end of communication pipe 521 (the downstream end of second communication pipe 521b) is open to the outside. In addition, cartridge main body 520a is in a state of being displaced with respect to slide part 520b. At this time, a portion of communication pipe 521 (the connection part between first communication pipe 521a and second communication pipe 521b) is squashed by cartridge main body 520a and slide part 520b. As a result, the channel between housing part 123 and packing 122 is in the “closed” state. Communication pipe 521 is not damaged in such a case, that is, even when the pipe is held in a state of being pulled between cartridge main body 520a and slide part 520b.

As illustrated in FIGS. 11D to 11F, when the channel between housing part 123 and packing 122 is in the “opened” state (in the case of cartridge 520 being held by chip holder 510), one end of communication pipe 521 (the upstream end of first communication pipe 521a) is connected to housing part 123, and the other end of communication pipe 521 (the downstream end of second communication pipe 521b) is located inside introduction port 240. In addition, cartridge main body 520a is in a state of being not displaced with respect to slide part 520b. At this time, communication pipe 521 is not squashed by cartridge main body 520a and slide part 520b and is linearly disposed. As a result, the channel between housing part 123 and packing 122 is in the “opened” state.

Sliding cartridge main body 520a with respect to slide part 520b thus can open and close the channel between housing part 123 and packing 122.

Operation of Liquid Handling System

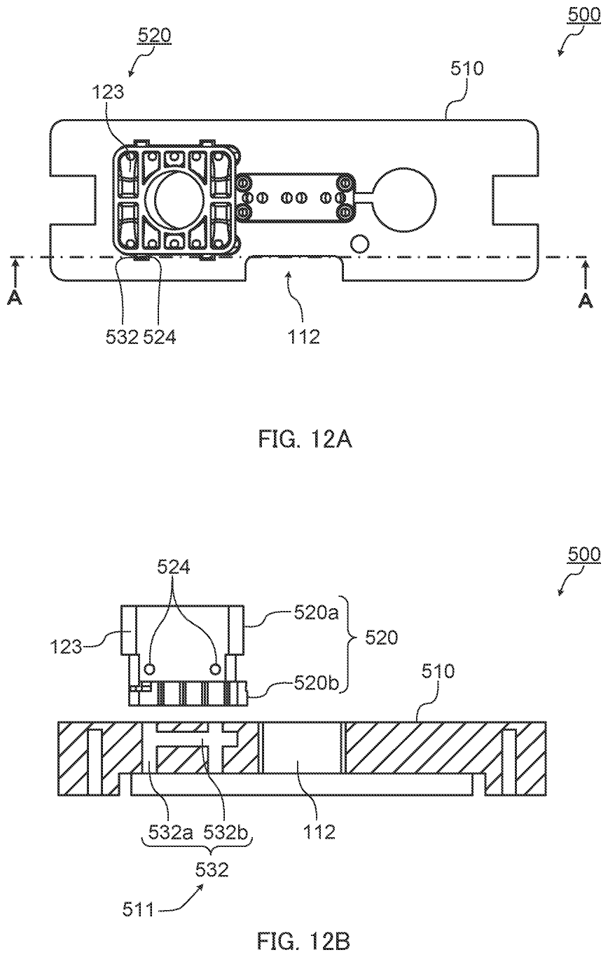

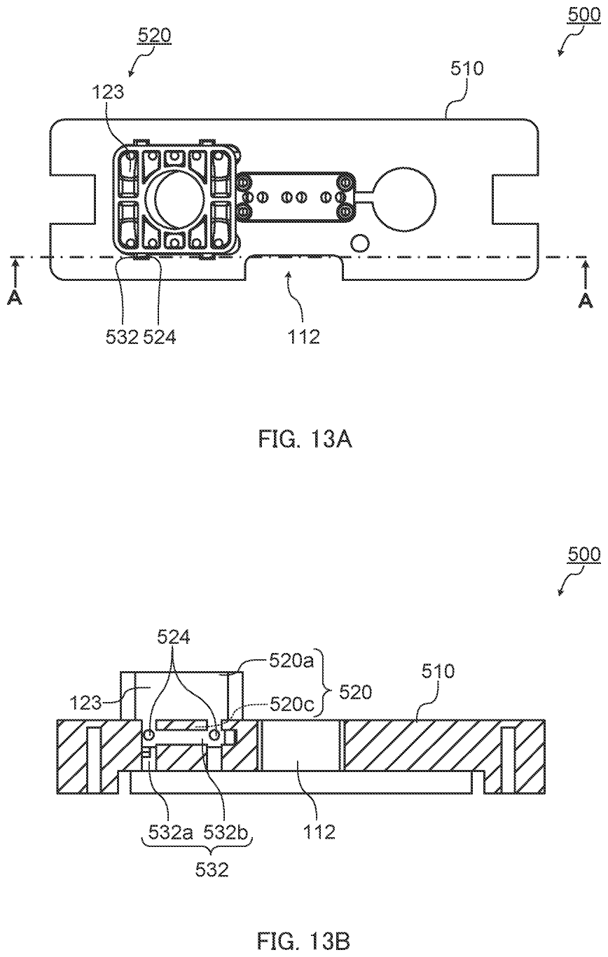

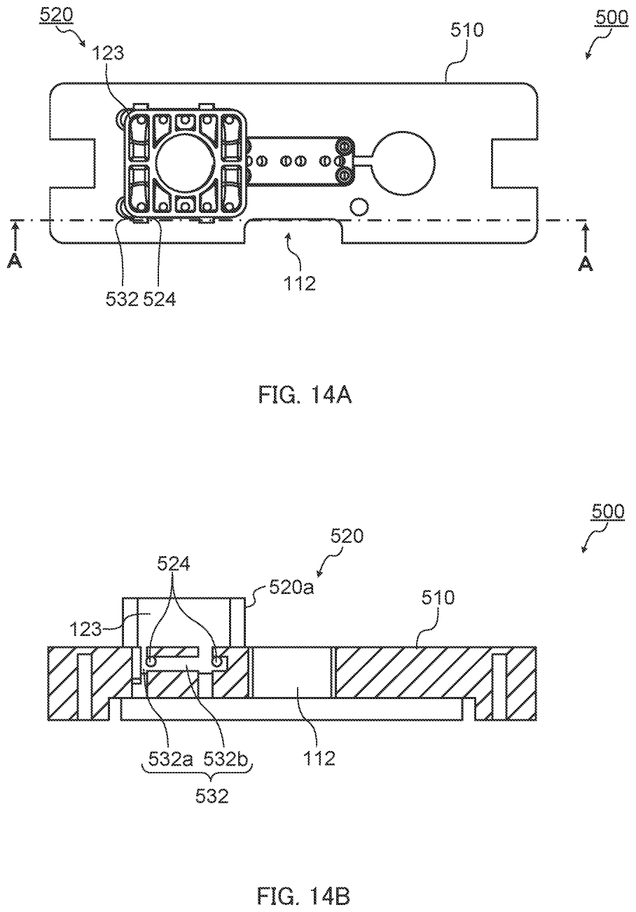

Hereinafter, a method for using liquid handling system 500 according to the present embodiment will be described. FIG. 12A is a plan view of part of liquid handling system 500 before communication pipes 521 of cartridge 520 are inserted into through holes 511. FIG. 12B is a cross-sectional view taken along line A-A in FIG. 12A. FIG. 13A is a plan view of part of liquid handling system 500 after communication pipes 521 of cartridge 520 are inserted into through holes 511. FIG. 13B is a cross-sectional view taken along line A-A in FIG. 13A. FIG. 14A is a plan view of part of liquid handling system 500 after second engagement parts 524 are engaged with first engagement parts 532. FIG. 14B is a cross-sectional view taken along line A-A in FIG. 14A.

First, channel chip 200 is inserted into chip holder 510 together with spacer 116 to dispose chip holder 510 in disposition part 131 of liquid handling device 530. Chip holder 510 is fixed by fixing parts 134 located on the upper portion of liquid handling device 530 (both not illustrated).

Next, cartridge 520 is installed at a predetermined position on chip holder 510. Specifically, communication pipes 521 are inserted into through holes 511 (see FIGS. 12A, 12B, 13A, and 13B). At this time, second engagement parts 524 of cartridge 520z is inserted into through hole 511 while being guided by first groove 523a of first engagement part 532. Slide part 520b of cartridge 520 contacts channel chip 200, thereby restricting the horizontal movement of slide part 520b. As a result, communication pipes 521 of cartridge 520 are inserted into introduction ports 240 of channel chip 200, thereby bringing housing parts 123 of cartridge 520 into a state of being able to communicate with corresponding introduction ports 240 of channel chip 200. In addition, packing 122 disposed at the tip of each communication pipe 521 is pressed by communication pipe 521 and introduction port 240 to seal introduction port 240. At this time, the channel between housing part 123 and packing 122 is “closed.”

Next, cartridge main body 520a is slid with respect to slide part 520b. Cartridge main body 520a moves while being guided by second groove 532b of first engagement part 532 at this time. As a result, the channel between housing part 123 and packing 122 is “opened,” and housing part 123 and introduction port 240 communicate with each other (see FIGS. 14A and 14B). The communication state between first communication pipe 521a and second communication pipe 521b is changed by sliding cartridge main body 520a with respect to slide part 520b in this manner.

With cartridge 520 fixed, button 133 disposed on liquid handling device 130 is pressed, thereby performing various processes, such as rotating first rotary member 300 to open and close the valves or rotating second rotary member 320 to drive the rotary membrane pump to move the liquid from introduction port 240 as illustrated in FIG. 9.

After various processes are completed, the engaged state between first engagement part 532 and second engagement part 524 can be easily released by bringing cartridge main body 520a into a state of being displaced with respect to slide part 520b to “close” the channel, and removing cartridge 520 from through hole 521.

Liquid handling device 530 according to the present embodiment includes disposition part 131, a plurality of buttons 133, and fixing parts 134. In addition, liquid handling device 530 includes jack 135, connector 136, first rotary member 300, and second rotary member 320. That is, liquid handling device 530 according to the present embodiment does not include first engagement part 132 of Embodiment 1.

Effects

As described above, in liquid handling system 500 according to the present embodiment, cartridge 520 can be easily fixed to or removed from channel chip 200. In addition, the channel between housing part 123 and packing 122 can be opened and closed; thus, cartridge 520 can be attached and removed without spilling a liquid from cartridge 520.

In liquid handling system 500 according to Embodiment 2, first engagement part 532 has a groove shape, and second engagement part 524 has a projection shape; however, first engagement part 523 may have a shape of recess 114, and second engagement part 524 may have a shape of bending part 125 and claw 126 as in Embodiment 1, for example. In this case, second engagement part 524 (having a shape of, for example, bending part 125 and claw 126) is formed on slide part 520b.

### OTHER EMBODIMENTS

The above-described embodiments are no more than specific examples in carrying out the present invention, and the technical scope of the present invention is not to be construed in a limitative sense due to the above-described embodiments. The present invention can be carried out in various forms without departing from the spirit and the main features thereof.

This application is entitled to and claims the benefit of PCT/JP2021/2207 filed on Jan. 22, 2021, the disclosure of which including the specification and drawings is incorporated herein by reference in its entirety.

### INDUSTRIAL APPLICABILITY

Liquid handling devices and liquid handling systems according to the present embodiments are particularly advantageous, for example, in a variety of applications such as clinical, food, and environmental testing.

### REFERENCE SIGNS LIST

100, 500 Liquid handling system
110, 510 Chip holder
111, 511 Through hole
112 First opening
114 Recess
115 Second opening
116 Spacer
120, 520 Cartridge
121, 521 Communication pipe
122 Packing
123 Housing part
124, 524 Second engagement part
125 Bending part
126 Claw
130 Liquid handling device
131 Disposition part
132, 532 First engagement part
133 Button
134 Fixing part
135 Jack
136 Connector
200 Channel chip
210 Substrate
220 Film
230 First channel
240 Introduction port
250 Valve
260 Rotary membrane pump
261 Diaphragm
270 Second channel
300 First rotary member
310 First main body
311 First protrusion
312 First recess
320 Second rotary member
330 Second main body
331 Second protrusion
521a First communication pipe
521b Second communication pipe
CA1 First central axis
CA2 Second central axis

1. A liquid handling system, comprising:
a channel chip including an introduction port for introducing a liquid and a channel for allowing a liquid introduced from the introduction port to flow therethrough;
a chip holder for housing the channel chip;
a cartridge housing a liquid to be introduced into the introduction port; and
a liquid handling device for supporting the chip holder and for controlling a flow of a liquid in the channel chip housed in the chip holder,
wherein
the channel chip, the chip holder, or the liquid handling device includes a first engagement part, and
the cartridge includes
a housing part housing a liquid,
a communication pipe configured to allow the housing part and the introduction port to communicate with each other,
packing disposed at the communication pipe, and
a second engagement part configured to detachably engage with the first engagement part,
wherein
the first engagement part and the second engagement part are configured in such a way that when the first engagement part and the second engagement part detachably engage with each other, the communication pipe is connected to the introduction port while the packing is pressed by the introduction port.

2. The liquid handling system according to claim 1, wherein:
the cartridge includes
a cartridge main body including the housing part, the second engagement part, and a first communication pipe that is a portion of the communication pipe, the portion being on a side of the housing part, and
a slide part configured to be slidable with respect to the cartridge main body, the slide part including the packing and a second communication pipe that is a portion of the communication pipe, the portion being on a side of the packing,
wherein
the second engagement part is included in the cartridge main body or in the slide part, and
a communication state between the first communication pipe and the second communication pipe is changed by sliding the cartridge main body with respect to the slide part.

3. The liquid handling system according to claim 1, wherein the first engagement part and the second engagement part are detachably engaged with each other by a snap fit mechanism.

4. The liquid handling system according to claim 3, wherein:
the second engagement part includes
a bending part extending along an extending direction of the communication pipe, and
a claw protruding toward a side opposite to the housing part, the claw being at an end portion of the bending part, the end portion being on a side of the channel chip,
wherein
in a state where the first engagement part and the second engagement part are engaged with each other, engagement between the first engagement part and the second engagement part is released by bending the bending part to move the claw toward the toward the housing part.

5. The liquid handling system according to claim 1, wherein the liquid handling device includes the first engagement part.

6. The liquid handling system according to claim 1, wherein:
the first engagement part is a groove included in the chip holder; and
the second engagement part is a projection configured to engage with the groove.

7. The liquid handling system according to claim 6, wherein:
the first engagement part includes
a first groove extending along an extending direction of the communication pipe, and
a second groove connected to the first groove, the second groove extending in a direction orthogonal to the extending direction of the communication pipe.

8. The liquid handling system according to claim 2, wherein the first engagement part and the second engagement part are detachably engaged with each other by a snap fit mechanism.

9. The liquid handling system according to claim 8, wherein:
the second engagement part includes
a bending part extending along an extending direction of the communication pipe, and
a claw protruding toward a side opposite to the housing part, the claw being at an end portion of the bending part, the end portion being on a side of the channel chip,
wherein
in a state where the first engagement part and the second engagement part are engaged with each other, engagement between the first engagement part and the second engagement part is released by bending the bending part to move the claw toward the toward the housing part.

10. The liquid handling system according to claim 2, wherein the liquid handling device includes the first engagement part.

11. The liquid handling system according to claim 3, wherein the liquid handling device includes the first engagement part.

12. The liquid handling system according to claim 4, wherein the liquid handling device includes the first engagement part.

13. The liquid handling system according to claim 8, wherein the liquid handling device includes the first engagement part.

14. The liquid handling system according to claim 9, wherein the liquid handling device includes the first engagement part.

15. The liquid handling system according to claim 2, wherein:
the first engagement part is a groove included in the chip holder; and
the second engagement part is a projection configured to engage with the groove.

16. The liquid handling system according to claim 15, wherein:
the first engagement part includes
a first groove extending along an extending direction of the communication pipe, and
a second groove connected to the first groove, the second groove extending in a direction orthogonal to the extending direction of the communication pipe.
